(19) United States
(12) Patent Application Publication
(10) Pub. No.: US 2012/0161061 A1
(43) Pub. Date: Jun. 28, 2012

(54) EXTRUDED SAN FOAMS

(75) Inventors: Klaus Hahn, Kirchheim (DE); Holger Ruckdäschel, St. Martin (DE); Ingo Bellin, Mannheim (DE); Peter Merkel, Zellertal (DE); Markus Hartenstein, Leimershiem (DE)

(73) Assignee: BASF SE, Ludwgshafen (DE)

(21) Appl. No.: 13/394,477

(22) PCT Filed: Sep. 6, 2010
(86) PCT No.: PCT/EP2010/063049

§ 371 Date: Mar. 6, 2012

(30) Foreign Application Priority Data
Sep. 7, 2009 (EP) 09169563.5

(51) Int. Cl. C08J 9/08; C08L 33/20; E04B 1/74; C08F 220/44

(52) U.S. Cl. 252/62; 521/147; 521/139; 521/79; 521/81

(57) ABSTRACT

Closed-cell extruded foam extruded foam with density in the range from 20 to 150 g/l and with a cell number in the range from 1 to 30 cells per mm is obtainable via
(a) heating of a polymer component P, formed from
P1) from 80 to 100% by weight (based on P) of one or more styrene-acrylonitrile copolymers (SAN), comprising
   a1) from 18 to 40% by weight (based on SAN) of copolymerized acrylonitrile,
   a2) from 60 to 82% by weight (based on SAN) of copolymerized styrene, and
   a3) from 0 to 22% by weight (based on SAN) of at least one copolymerized monomer from the group consisting of alkyl(meth)acrylates, (meth)acrylic acid, maleic anhydride and maleimides,
P2) from 0 to 20% by weight (based on P) of one or more thermoplastic polymers from the group consisting of styrene copolymers, polyolefins, polyacrylates, polycarbonates (PC), polyesters, polyamides, polyether sulfones (PES), polyether ketones (PEK), and polyether sulfides,
to form a polymer melt,
(b) introduction of from 1 to 12% by weight (based on P) of a blowing agent component (T), which comprises less than 0.2% by weight of water (based on P), comprising
   b1) from 15 to 95% by weight (based on T) of carbon dioxide and
   b2) from 5 to 85% by weight (based on T) of one or more co-blowing agents selected from the group consisting of C₁-C₄ alcohols and C₁-C₄ carbonyl compounds,
   into the polymer melt to form a foamable melt,
(c) extrusion of the foamable melt into a region of relatively low pressure, with foaming to give the extruded foam,
(d) if appropriate, addition of additives to the polymer component (P) in at least

The invention relates to extruded foams obtainable via heating of a styrene-acrylonitrile copolymer (SAN) to form a polymer melt, introduction of a blowing agent component into the polymer melt, if appropriate addition of auxiliaries and additives, and foaming of the polymer melt. The invention further relates to a process for the production of the extruded foams, and also to the use of the extruded foams as insulation material and as structural foam.

Polystyrene-based extruded foams are widely used in the construction industry for the insulation of parts of buildings, for example foundations, walls, floors, and roofs. This application requires extruded foams that have minimal thermal conductivity and therefore high insulation capability. In order to achieve good insulation properties, it is preferable to use closed-cell extruded foams, since these have markedly better insulation capability than open-cell extruded foams.

Extruded foams used in the construction industry are expected to have not only good insulation properties but also good heat resistance, together with low density. Heat resistance is very important especially for applications where the foams are exposed to high temperatures, since otherwise the extruded foams can deform, with resultant damage to the insulation system. Examples of components where good heat resistance is particularly useful are roof insulation systems and wall insulation systems that are exposed to direct insolation.

Extruded foams should have not only good insulation properties and good heat resistance but also good resistance to solvents, especially to oil and petroleum. This is a particular requirement for components used in the lower parts of walls, in foundations, and in floors. DE 10 2004 057 602 A1 describes extruded foam sheets based on styrene polymers which have reduced thermal conductivity. Polystyrene polymers disclosed are not only polystyrene but also copolymers which can comprise, alongside at least 50% by weight of copolymerized styrene, other comonomers from the group of a-methylstyrene, ring-halogenated styrenes, ring-alkylated styrenes, acrylonitrile, (meth)acrylic esters of alcohols having from 1 to 8 carbon atoms, N-vinyl compounds, maleic anhydride, and small amounts of compounds having two polymerizable double bonds. The blowing agent used preferably comprises a blowing agent mixture composed of from 95 to 20% by weight of carbon dioxide, from 5 to 80% by weight of water, and from 0 to 75% by weight of an alcohol, ketone, or ester. The only example of DE 10 2004 057 602 extrudes straight polystyrene with a 1:1 mixture of carbon dioxide and ethanol. According to the teaching of DE 10 2004 057 602, the foam sheets exhibit good insulation properties. However, there is still room for improvement in respect of heat resistance and solvent resistance.

DE-A 103 21 787 discloses a process for the production of foam sheets based on styrene-acrylonitrile copolymers, where these have improved solvent resistance. The blowing agent or blowing agent component used comprises water. The foam sheets obtainable by said process have good solvent resistance. However, there is still room for improvement in respect of heat resistance and insulation properties.

The object of the invention is therefore to provide extruded foams which have good insulation properties, good solvent resistance, and good heat resistance. The extruded foams are moreover intended to have a homogeneous cell structure and to be obtainable without the use of environmentally hazardous blowing agents, such as fluorochlorocarbons, or of highly combustible blowing agents, such as alkanes.

The object is achieved via a closed-cell extruded foam with density in the range from 20 to 150 g/l and with a cell number in the range from 1 to 30 cells per mm, obtainable via
(a) heating of a polymer component (P), formed from
P1) from 80 to 100% by weight (based on P) of one or more styrene-acrylonitrile copolymers (SAN), comprising
   a1) from 18 to 40% by weight (based on SAN) of copolymerized acrylonitrile,
   a2) from 60 to 82% by weight (based on SAN) of copolymerized styrene, and
   a3) from 0 to 22% by weight (based on SAN) of at least one copolymerized monomer from the group consisting of alkyl(meth)acrylates, (meth)acrylic acid, maleic anhydride and maleimides,
P2) from 0 to 20% by weight (based on P) of one or more thermoplastic polymers from the group consisting of styrene copolymers, polyolefins, polyacrylates, polycarbonates (PC), polyesters, polyamides, polyether sulfones (PES), polyether ketones (PEK), and polyether sulfides,
   to form a polymer melt,
(b) introduction of from 1 to 12% by weight (based on P) of a blowing agent component (T), which comprises less than 0.2% by weight of water (based on P) comprising;
   b1) from 15 to 95% by weight (based on T) of carbon dioxide and
   b2) from 5 to 85% by weight (based on T) of one or more co-blowing agents selected from the group consisting of C₁-C₄ alcohols and C₁-C₄ carbonyl compounds
   into the polymer melt to form a foamable melt,
(c) extrusion of the foamable melt into a region of relatively low pressure, with foaming to give the extruded foam,
(d) if appropriate, addition of additives to the polymer component P in at least one of the steps a), b) and/or c).

The invention further provides the process described for the production of the extruded foam of the invention, and also the use of this foam as insulation material and as structural foam.

The extruded foam of the invention has good insulation properties, good solvent resistance, and good heat resistance. It thus combines three important properties in a single material, therefore having the versatility for use in a very wide variety of applications where hitherto it has been necessary to use different materials specifically adapted for the respective use. The extruded foam of the invention is obtainable without the use of blowing agents that are problematic because of their effect on the environment or because of fire-protection regulations. Furthermore, although the density of the foam is low it is superior to prior-art extruded foams in terms of good insulation properties and mechanical properties, while at the same time having high solvent resistance and high heat resistance.

For the purposes of the invention, the term “closed-cell extruded foam” means that measurements made to DIN ISO 4590 indicate that at least 90% of the cells are closed cells.

The SAN (P1) and the thermoplastic polymers (P2) used according to the invention as polymer component (P) can be produced by processes known to the person skilled in the art, for example by free-radical, anionic, or cationic polymerization, in bulk, solution, dispersion, or emulsion. Preference is given to production by free-radical polymerization.

The SAN generally comprises from 18 to 40% by weight, preferably from 25 to 35% by weight, and in particular from 30 to 35% by weight, of copolymerized acrylonitrile and generally from 60 to 82% by weight, preferably from 65 to 75% by weight, and particularly preferably from 65 to 70% by weight, of copolymerized styrene (based in each case on SAN).

It is preferable that the SAN is composed of components a1) and a2) and also, if appropriate, a3).

The SAN can, if appropriate, comprise from 0 to 22% by weight (based on P) of at least one copolymerized monomer from the group consisting of alkyl(meth)acrylates, (meth)acrylic acid, maleic anhydride and maleimides (component a3)).

For the purposes of the invention, alkyl(meth)acrylates are either alkyl acrylates or alkyl methacrylates. (Meth)acrylic acid means either acrylic acid or methacrylic acid.

Preferred alkyl(meth)acrylates are formed from (meth)acrylic acid and from C₁-C₆ alcohols, such as methanol, ethanol, 1-propanol, 2-propanol, n-butanol, sec-butanol, isobutanol, tert-butanol, and from pentanol and its derivatives, hexanol and its derivatives, and cyclohexanol.

Preferred maleimides are maleimide itself, N-alkyl-substituted maleimides, and N-phenyl-substituted maleimides.

In one preferred embodiment, the SAN comprises no monomer of component a3), and the SAN is therefore exclusively composed of acrylonitrile and styrene as monomer components.

The melt volume rate MVR (220° C./10 kg) of the SAN (P1) which can be used in the process according to the invention is generally in the range from 5 to 20 cm³/10 min, to ISO 113.

Examples of suitable types of SAN (SAN; component P1) are polymers such as Luran 3380, Luran 33100 and Luran 2580, from BASF SE.

In one preferred embodiment, the extruded foam of the invention comprises one (1) styrene-acrylonitrile copolymer.

In another preferred embodiment, the extruded foam of the invention comprises from two to four, preferably two, styrene-acrylonitrile copolymers.

Thermoplastic polymers (P2) used in polymer component P may be one or more thermoplastic polymers from the group consisting of styrene copolymers, polyolefins, polyacrylates, polycarbonates (PC), polyesters, polyamides, polyether sulfones (PES), polyether ketones (PEK), and polyether sulfides (PES).

Examples of suitable styrene copolymers (as component P2) are acrylonitrile-butadiene-styrene (ABS), styrene-maleic anhydride (SMA), acrylonitrile-styrene-acrylate (ASA), and styrene-methacrylic acid.

Another component (P2) that can be used is polystyrene. However, this is not preferred.

Examples of suitable polyolefins (as component P2) are polypropylene (PP), polyethylene (PE), and polybutadiene.

An example of a suitable polyacrylate (as component P2) is polymethyl methacrylate (PMMA).

Examples of suitable polyesters (as component P2) are polyethylene terephthalate (PET) and polybutylene terephthalate (PBT).

Examples of suitable polyamides (as component P2) are nylon-6 (PA6), nylon-6,6, nylon-6,I, and nylon-6/6,6.

In one preferred embodiment, polymer component (P) comprises no (0% by weight of) styrene copolymer (as component P2).

In another preferred embodiment, polymer component (P) comprises no (0% by weight of) thermoplastic polymer (P2).

In another preferred embodiment, polymer component (P) (and therefore also the extruded foam) comprises from 0 to 15% by weight, particularly preferably from 0 to 5% by weight, with particular preference 0% by weight, of the polymer P2 (based in each case on P).

In another preferred embodiment, polymer component (P) (and therefore also the extruded foam) comprises from 0.1 to 20% by weight, particularly preferably from 0.5 to 10% by weight, with particular preference from 1 to 5% by weight, of the polymer (P2) (based in each case on P)

In another preferred embodiment, polymer component (P) comprises exclusively acrylonitrile and styrene as monomers (0% by weight of a3) and 0% by weight of P2).

In one embodiment, the density of the extruded foam is in the range from 50 to 130 g/l, preferably from 60 to 120 g/l.

In another embodiment, the density of the extruded foam is in the range from 20 to 60 g/l, preferably from 20 to 50 g/l, and with particular preference in the range from 25 to 45 g/l.

The invention also provides a process for the production of a closed-cell extruded foam with density in the range from 20 to 150 g/l, with a cell number in the range from 1 to 30 cells per mm via
(a) heating of a polymer component (P), formed from
P1) from 80 to 100% by weight (based on P) of one or more styrene-acrylonitrile copolymers (SAN), comprising
   a1) from 18 to 40% by weight (based on SAN) of copolymerized acrylonitrile,
   a2) from 60 to 82% by weight (based on SAN) of copolymerized styrene, and
   a3) from 0 to 22% by weight (based on SAN) of at least one copolymerized monomer from the group consisting of alkyl(meth)acrylates, (meth)acrylic acid, maleic anhydride and maleimides,
P2) from 0 to 20% by weight (based on P) of one or more thermoplastic polymers from the group consisting of styrene copolymers, polyolefins, polyacrylates, polycarbonates (PC), polyesters, polyamides, polyether sulfones (PES), polyether ketones (PEK), and polyether sulfides,
   to form a polymer melt,
(b) introduction of from 1 to 12% by weight (based on P) of a blowing agent component (T), which comprises less than 0.2% by weight of water (based on P), comprising
   b1) from 15 to 95% by weight (based on T) of carbon dioxide and
   b2) from 5 to 85% by weight (based on T) of one or more co-blowing agents selected from the group consisting of C₁-C₄ alcohols and C₁-C₄ carbonyl compounds,
   into the polymer melt to form a foamable melt,
(c) extrusion of the foamable melt into a region of relatively low pressure, with foaming to give the extruded foam,
(d) if appropriate, addition of additive materials to the polymer component P in at least one of the steps a), b) and/or c).

In step (a) of the process, polymer component (P) is heated in order to obtain a polymer melt. For the purposes of the invention, formation of a polymer melt means plastification of the polymer component (P) in the wider sense, i.e. conversion of the solid constituents of the polymer component (P) into a deformable or flowable condition. For this, it is necessary to heat the polymer component (P) to a temperature above the melting point or glass transition temperature. Suitable temperatures are generally at least 150° C., preferably from 160 to 280° C., particularly preferably from 180 to 240° C.

The heating of the polymer component (P) (step (a) of the process of the invention) can be achieved by means of any desired equipment known in the technical sector, for example by means of an extruder, or of a mixer (e.g. a kneader). It is preferable to use primary extruders. Step (a) of the process of the invention can be carried out continuously or batchwise, preferably continuously.

Step (b) of the process of the invention comprises the introduction of blowing agent component T into the polymer melt produced in step (a), to form a foamable melt.

The blowing agent component (T) comprises (and preferably consists of)
(b1) from 95 to 15% by weight, preferably from 85 to 15% by weight, particularly preferably from 75 to 15% by weight (based on (T)), of CO₂,
(b2) from 5 to 85% by weight, preferably from 15 to 85% by weight, particularly preferably from 25 to 85% by weight (based on T) of one or more, preferably of one or two, in particular of one, co-blowing agent(s) from the group of the C₁-C₄ alcohols and C₁-C₄ carbonyl compounds, preferably C₂-C₄-carbonyl compounds, in particular C₃-C₄ ketones and formates, and also
(b3) less than 0.2% by weight of water, preferably from 0 to 0.18% by weight, more preferably from 0 to 0.14% by weight, particularly preferably from 0 to 0.1% by weight, with particular preference from 0 to 0.8% by weight, and most preferably from 0 to 0.05% by weight, of water (in each case based on P).

The blowing agent component (T) used is preferably a mixture of two or more blowing agents. Binary and ternary mixtures are particularly preferred.

Preferred alcohols are methanol, ethanol, 1-propanol, 2-propanol, 1-butanol, 2-butanol, 2-methylpropanol and tert-butanol. Particular preference is given to 2-propanol and ethanol. Ethanol is particularly preferred.

C₁-C₄ carbonyl compounds are ketones, aldehydes, carboxylic esters, and also carboxamides having from 1 to 4 carbon atoms.

Suitable ketones are acetone and methyl ethyl ketone, and preferred formates are methyl formate, ethyl formate, n-propyl formate, and isopropyl formate. Preference is given to methyl formate and acetone. Acetone is particularly preferred.

Water b3) can be present in the co-blowing agents b2) and in the carbon dioxide b1). Water passes into blowing agent component (T) mainly via the use of technical-grade alcohols and ketones. The concentrations of water in blowing agent component (T) are within the abovementioned concentration ranges.

In one preferred embodiment, the blowing agent component is in essence anhydrous. Particular preference is given to mixtures of carbon dioxide and ethanol, carbon dioxide and acetone, carbon dioxide and methyl formate, and carbon dioxide and mixtures composed of ethanol and acetone in the abovementioned mixing ratios.

The total proportion of blowing agent component (T) added to the polymer melt is from 1 to 12% by weight, preferably from 1 to 8% by weight and particularly preferably from 1.5 to 7% by weight (based in each case on P).

In one preferred embodiment, the proportion of blowing agent component (T) added to the polymer melt is from 1 to 4.5% by weight (based on P).

In another preferred embodiment the proportion of blowing agent component T added to the polymer melt is from 2.5 to 8% by weight (based on P).

A suitable constitution of blowing agent component (T) comprises from 15 to 95% by weight of component b1) and from 5 to 85% by weight of component b2). The proportion of component b1), based on P, is preferably less than 6% by weight, and the proportion of component b2), based on P, is preferably less than 5% by weight, and the total proportion of components b1) and b2), based on P is preferably less than 8% by weight. It is particularly preferable that the proportion of component b1), based on P, is less than 4.5% by weight, and that the proportion of component b2), based on P, is less than 4% by weight.

In one particularly preferred embodiment, the proportion of blowing agent component (T) added to the polymer melt is from 1 to 4.5% by weight, based on (P), and the blowing agent component comprises from 15 to 40% by weight (based on T) of carbon dioxide (component b1).

In another particularly preferred embodiment the proportion of blowing agent component (T) added to the polymer melt is from 1 to 4.5% by weight, based on (P), the blowing agent component comprises from 15 to 40% by weight (based on T) of carbon dioxide (component b1), and the density of the extruded foam is in the range from 50 to 130 WI, preferably from 60 to 120 g/l.

In another particularly preferred embodiment the proportion of blowing agent component (T) added to the polymer melt is from 2.5 to 8% by weight (based on P) and the blowing agent component comprises from 55 to 75% % by weight (based on T) of carbon dioxide (component b1).

In another particularly preferred embodiment the proportion of blowing agent component (T) added to the polymer melt is from 2.5 to 8% by weight (based on P), the blowing agent component comprises from 55 to 75% by weight, (based on T) of carbon dioxide (component b1), and the density of the extruded foam is in the range from 20 to 60 g/l, preferably from 20 to 50 g/l, and with particular preference from 25 to 45 g/l.

Any of the methods known to the person skilled in the art can be used to incorporate blowing agent component (T) into a molten polymer component (P). By way of example, extruders or mixers (e.g. kneaders) are suitable. In one preferred embodiment, the blowing agent is mixed at elevated pressure with the molten polymer component (P). The pressure here must be sufficiently high for substantial prevention of foaming of the molten polymer material and for homogeneous dispersion of blowing agent component (T) in molten polymer component P. Suitable pressures are from 50 to 500 bar (absolute), preferably from 100 to 300 bar (absolute), particularly preferably from 150 to 250 bar (absolute). The temperature in step (b) of the process of the invention has to be selected in such a way that the polymeric material is molten. For this, it is necessary that polymer component (P) is heated to a temperature above the melting point or glass transition temperature. Suitable temperatures are generally at least 150° C., preferably from 160 to 280° C., particularly preferably from 180 to 240° C.

The blowing agent can be added in the primary extruder or in a downstream step.

In one preferred embodiment, the foamable polymer melt is passed through XPS extruders known to the person skilled in the art, for example by way of a tandem structure composed of primary extruder and secondary extruder. Continuous and batch methods are possible for the process, where polymer component (P) is melted in the primary extruder (step (a)), and the blowing agent is added (step (b)) to form a foamable melt, likewise in the primary extruder.

The foamable melt provided with blowing agent is then cooled in the secondary extruder to a temperature of from 50 to 180° C., which is suitable for the foaming process, preferably to a temperature of from 80 to 150° C.

In one embodiment, additive materials, i.e. auxiliaries and/or additives, are added to polymer component P prior to conduct of the process and/or in at least one of the steps a), b), and/or c). Suitable auxiliaries and additives are known to the person skilled in the art.

In one preferred embodiment, at least one nucleating agent is added to polymer component (P). The nucleating agents used can comprise fine-particle, inorganic solids, such as talc, metal oxides, silicates, or polyethylene waxes, the amounts of these generally being from 0.1 to 10% by weight, preferably from 0.1 to 3% by weight, particularly preferably from 1 to 1.5% by weight, based on P. The average particle diameter of the nucleating agent is generally in the range from 0.01 to 100 μm, preferably from 1 to 60 μm. Talc is a particularly preferred nucleating agent, an example being talc from the company Luzenac Pharma. Methods known to the person skilled in the art can be used to add the nucleating agent. It can be added prior to conduct of the process and/or in step a) and/or b) and/or c).

It is possible if desired to add one or more additive materials, examples being seeding agents, fillers (e.g. mineral fillers, such as glass fibers), plasticizers, flame retardants, IR absorbers, such as carbon black or graphite, aluminum powder and titanium dioxide, and soluble and insoluble dyes and pigments. Graphite and carbon black are preferred additives.

Particular preference is given to adding amounts of graphite which are generally from 0.05 to 25% by weight, particularly preferred amounts being from 2 to 8% by weight, based on P. Suitable particle sizes for the graphite used are in the range from 1 to 50 μm, preferably in the range from 2 to 10 μm.

It is preferable to add one or more flame retardants for compliance with the fire-protection regulations in the building and other industries. Examples of suitable flame retardants are tetrabromobisphenol A, brominated polystyrene oligomers, tetrabromobisphenol A diallyl ether, expanded graphite, red phosphorus, triphenyl phosphate, and 9,10-dihydro-9-oxa-10-phosphaphenanthrene 10-oxide. Another example of a suitable flame retardant is hexabromocyclododecane (HBCD), in particular the technical-grade products, which consist essentially of the α-, β-, and γ-isomer, preferably with added synergists, i.e. dicumyl (2,3-dimethyl-2,3-diphenyl-butane). Particular preference is given to brominated aromatics, such as tetrabromobisphenol A, and to brominated polystyrene oligomers.

For thermal insulation it is particularly preferable to add graphite, carbon black, aluminum powder, or an IR dye (e.g. indoaniline dyes, oxonol dyes or anthraquinone dyes).

The amounts generally added (based on P) of the dyes and pigments are in the range from 0.01 to 30% by weight, preferably in the range from 1 to 5% by weight. For homogeneous microdispersion of the pigments in the polymer melt it can be particularly advantageous in the case of polar pigments to use a dispersing agent, e.g. organosilanes, polymers containing epoxy groups, or maleic-anhydride-grafted styrene polymers. Preferred plasticizers are fatty acid esters, fatty acid amides, and phthalates, and the amounts of these that can be used are from 0.05 to 10% by weight, based on polymer component (P).

The total amount of additive materials is generally from 0 to 30% by weight, preferably from 0 to 20% by weight, based on the total weight of the extruded foam.

In one preferred embodiment, the total amount of additive materials is from 0.5 to 30% by weight, particularly preferably from 0.5 to 20% by weight (based on the total weight of the extruded foam).

In another embodiment, the extruded foam comprises no additive materials.

Step (c) of the process of the invention comprises the foaming of the foamable melt in order to obtain an extruded foam.

For this, the melt is conveyed through a suitable apparatus, such as a die plate. The die plate is heated at least to the temperature of the polymer melt comprising blowing agent. It is preferable that the temperature of the die plate is from 60 to 200° C. It is particularly preferable that the temperature of the die plate is from 110 to 180° C.

The polymer melt comprising blowing agent is transferred through the die plate into a region in which the prevailing pressure is lower than in the region in which the foamable melt is held prior to extrusion through the die plate. The relatively low pressure can be superatmospheric pressure or subatmospheric pressure. It is preferable to extrude into a region using atmospheric pressure.

Step (c) is likewise carried out at a temperature at which the polymeric material to be foamed is molten, generally at temperatures of from 50 to 170° C., preferably from 90 to 150° C., particularly preferably from 110 to 140° C. Because, in step (c), the polymer melt comprising blowing agent is transferred into a region in which the prevailing pressure is relatively low, the blowing agent becomes gaseous. The polymer melt is expanded and foamed by virtue of the large increase in volume.

The geometric shape of the cross section of the extruded foam obtainable by the process of the invention is substantially determined via the selection of the die plate and, if appropriate, via suitable downstream equipment, such as sheet calibrators, roller-conveyor take-offs, or belt take-offs, and is freely selectable.

The extruded foams obtainable by the process of the invention preferably have a rectangular cross section. The thickness of the extruded foams is determined here by the height of the slot in the die plate. The width of the extruded foams is determined by the width of the slot in the die plate. The length of the extruded foam parts is determined in a downstream operation via processes familiar to the person skilled in the art, e.g. adhesive bonding, welding, sawing and cutting. Particular preference is given to extruded foam parts in the form of a sheet. This means that the thickness (height) dimension is small in comparison with the width dimension and the length dimension of the molding.

The compressive strength of the extruded foam parts obtainable by the process of the invention is generally in the range from 0.15 to 6 N/mm², preferably in the range from 0.3 to 2 N/mm², measured to DIN EN 826. The density of the foam sheets is preferably in the range from 20 to 150 g/l. It is preferable that at least 90%, in particular from 95 to 100%, of the cells of the extruded foams of the invention are closed cells, measured to DIN ISO 4590.

The cell number of the extruded foam of the invention is in the range from 1 to 30 cells per mm, preferably from 3 to 25 cells per mm, and with particular preference from 3 to 20 cells per mm.

The invention also provides the use of the extruded foams of the invention and of the moldings obtainable therefrom. Preference is given to the use as insulating material in particular in the building industry, below and above ground, e.g. for foundations, walls, floors, and roofs. Preference is likewise given to the use as structural foam, in particular for lightweight construction applications and as core material for composite applications.

The examples below provide further explanation of the invention, but there is no intention that they restrict the invention.

### EXAMPLES

Materials Used
Luran 3360 SAN having 33% by weight acrylonitrile content and intrinsic viscosity of 60 ml/g (product commercially available from BASF SE)
Luran 3380 SAN having 33% by weight acrylonitrile content and intrinsic viscosity of 80 ml/g (product commercially available from BASF SE)
Luran 33100 SAN having 33% by weight acrylonitrile content and intrinsic viscosity of 100 ml/g (product commercially available from BASF SE)
Luran 2580 SAN having 25% by weight acrylonitrile content and intrinsic viscosity of 80 ml/g (product commercially available from BASF SE)
Talc Talc IT Extra, Luzenac Pharma

General Operating Specification

The polymers used were continuously introduced into a primary extruder, together with talc. The total throughput of the polymers was 7 kg/h. The blowing agents (CO₂, ethanol, acetone and/or methyl formate) were introduced continuously through an injection aperture in the primary extruder. The melt comprising blowing agent was cooled in a downstream secondary extruder and extruded through a slot die. The foaming melt was drawn off by way of a roller conveyor, without calibration.

Table 1 shows the effect of different blowing agent components (T) in the same polymer composition.

TABLE 1

| | SAN | | | | | | |
|---|---|---|---|---|---|---|---|
| | (Luran | | | | | | Proportion of |
| Example | 3380) | Talc | CO₂ | Ethanol | Water | Density | closed cells* |
| No. | (phr) | (phr) | (phr) | (phr) | (phr) | (g/l) | (—) |
| comp. 1 | 100 | 0.25 | 3.6 | — | | 180 | >95% |
| comp. 2 | 100 | 0.25 | 5.0 | — | | 130 | >95% |
| E1 | 100 | 0.25 | 3.6 | 1.5 | | 57 | >95% |
| E2 | 100 | 0.25 | 3.6 | 2.0 | | 55 | >95% |
| E3 | 100 | 0.25 | 3.6 | 2.5 | | 52 | >95% |
| E4 | 100 | 0.25 | 5.0 | 2.5 | | 35 | >95% |
| comp. 3 | 100 | 0.25 | 2.0 | | 2.0 | 35 | <80% |
| comp. 4 | 100 | 0.25 | 4.0 | 1.0 | 1.0 | 30 | <20% |

phr = Proportions by weight
*measured to DIN ISO 4590

Comparative examples comp. 1 and comp. 2 have high densities which are unacceptable for extruded foams for use in the building industry. The cell structure in comp. 2 is moreover not completely homogeneous. Because of low values for the proportion of closed cells, comparative examples comp. 3 and comp. 4 exhibit unsatisfactory isolation properties.

Table 2 shows extruded foams of the invention (E3-E6) using SAN of different molecular weights.

TABLE 2
SAN of different molecular weights with CO₂ + ethanol

| | | | | | | | Proportion of |
|---|---|---|---|---|---|---|---|
| Ex. | SAN | | Talc | CO₂ | Ethanol | Density | closed cells* |
| no. | Type | (phr) | (phr) | (phr) | (phr) | (g/l) | (—) |
| E5 | Luran 3360 | 100 | 0.25 | 3.6 | 2.0 | 55 | >95% |
| E6 | Luran 3380 | 100 | 0.25 | 3.6 | 2.0 | 55 | >95% |
| E7 | Luran 33100 | 100 | 0.25 | 3.6 | 2.0 | 60 | >95% |
| E8 | Luran 2580 | 100 | 0.25 | 3.6 | 2.0 | 55 | >95% |

*measured to DIN ISO 4590

Table 3 compares the proportion of closed cells for example E7 and comparative example comp. 5.

TABLE 3
SAN with CO₂ + ethanol, addition of polystyrene (PS)

| | SAN | PS | Talc | | | | |
|---|---|---|---|---|---|---|---|
| | (Luran | (PS | (Lucenac | | | | Proportion of |
| | 3380) | 158K) | Pharma) | CO₂ | Ethanol | Density | closed cells * |
| | (phr) | (phr) | (phr) | (phr) | (phr) | (g/l) | (—) |
| E9 | 100 | 0 | 0.25 | 3.6 | 2 | 55 | >95% |
| comp. 5 | 80 | 20 | 0.25 | 3.6 | 2 | 50 | <70% |

* measured to DIN ISO 4590

Although the addition of polystyrene provides slight advantages in density, it reduces the proportion of closed cells unacceptably.

Table 4 shows that extruded foams of the invention are compatible with familiar flame retardants.

TABLE 4
SAN with different flame retardants (HBCD, TBBPA)

| | | | | | | | | | Fire test |
|---|---|---|---|---|---|---|---|---|---|
| | SAN | | | | | | | | (based on |
| | (Luran | | | | | | | | DIN 4102 |
| | 3380) | HBCD*** | | Dicumyl | Talc | CO₂ | Ethanol | Density | B2 Test) |
| | (phr) | (phr) | TBBPA** | (phr) | (phr) | (phr) | (phr) | (g/l) | (—) |
| E2 | 100 | | | | 0.25 | 3.6 | 2.0 | 55 | not passed |
| E10 | 100 | 2.0 | | 0.25 | 0.25 | 3.6 | 2.0 | 55 | passed |
| E11 | 100 | | 4.0 | | 0.25 | 3.6 | 2.0 | 55 | passed |

**tetrabromobisphenol A
***hexabromocyclododecane

Table 5 shows the effect of different blowing agent components (T), and specifically acetone, and of different blowing agent concentrations, for an identical polymer composition.

TABLE 5

| | SAN | | | | | | |
|---|---|---|---|---|---|---|---|
| | (Luran | | | | | | Proportion of |
| Example | 3380) | Talc | CO₂ | Ethanol | Acetone | Density | closed cells * |
| No. | (phr) | (phr) | (phr) | (phr) | (phr) | (g/l) | (—) |
| E1 | 100 | 0.25 | 3.6 | 1.5 | | 57 | >95% |
| E12 | 100 | 0.25 | 3.6 | 0.75 | 0.75 | 48 | >95% |
| E13 | 100 | 0.25 | 3.6 | 0.38 | 1.12 | 53 | >95% |
| E14 | 100 | 0.25 | 3.6 | | 1.5 | 60 | >95% |
| E15 | 100 | 0.25 | 3.6 | | 3.0 | 55 | >95% |

Comparative examples E12 to E15 show that acetone can be used similarly to ethanol as suitable co-blowing agent.

Table 6 shows the effect of different blowing agent components (T), and specifically methyl formate, and of different blowing agent concentrations, for an identical polymer composition.

TABLE 6

| | SAN | | | | | | |
|---|---|---|---|---|---|---|---|
| | (Luran | | | | Methyl | | Proportion of |
| Example | 3380) | Talc | CO₂ | Ethanol | formate | Density | closed cells * |
| No. | (phr) | (phr) | (phr) | (phr) | (phr) | (g/l) | (—) |
| E1 | 100 | 0.25 | 3.6 | 1.5 | | 57 | >95% |
| E16 | 100 | 0.25 | 3.6 | 0.75 | 0.75 | 55 | >95% |
| E17 | 100 | 0.25 | 3.6 | | 1.5 | 53 | >95% |

* measured to DIN ISO 4590

Comparative examples E16 and E17 show that methyl formate can be used similarly to ethanol as a suitable co-blowing agent.

1-19. (canceled)

20. A closed-cell extruded foam with density in the range from 20 to 150 g/l and with a cell number in the range from 1 to 30 cells per mm, obtainable via
(a) heating a polymer component (P), formed from
P1) from 80 to 100% by weight (based on P) of one or more styrene-acrylonitrile copolymers (SAN), comprising
a1) from 18 to 40% by weight (based on SAN) of copolymerized acrylonitrile,
a2) from 60 to 82% by weight (based on SAN) of copolymerized styrene, and
a3) from 0 to 22% by weight (based on SAN) of at least one copolymerized monomer from the group consisting of alkyl(meth)acrylates, (meth)acrylic acid, maleic anhydride and maleimides,
P2) from 0 to 20% by weight (based on P) of one or more thermoplastic polymers from the group consisting of styrene copolymers, polyolefins, polyacrylates, polycarbonates (PC), polyesters, polyamides, polyether sulfones (PES), polyether ketones (PEK), and polyether sulfides,
to form a polymer melt,
(b) introducing from 1 to 12% by weight (based on P) of a blowing agent component (T), which comprises less than 0.2% by weight of water (based on P), comprising
b2) from 15 to 95% by weight (based on T) of carbon dioxide and
b2) from 5 to 85% by weight (based on T) of one or more co-blowing agents selected from the group consisting of C₁-C₄ alcohols and C₁-C₄ carbonyl compounds;
into the polymer melt to form a foamable melt,
(c) extruding the foamable melt into a region of relatively low pressure, with foaming to give the extruded foam,
(d) optionally, adding additives to the polymer component (P) in at least one of the steps a), b) and/or c).

21. The extruded foam according to claim 20, using from 1 to 8% by weight of blowing agent component (T), comprising
b1) from 15 to 95% by weight (based on T) of carbon dioxide and
b2) from 5 to 85% by weight (based on T) of one or more co-blowing agents selected from the group consisting of C₁-C₄ alcohols, C₃-C₄ ketones, and C₂-C₄ esters.

22. The extruded foam according to claim 20, wherein polymer component (P) is composed exclusively of component (P1).

23. The extruded foam according to claim 20, wherein polymer component (P) comprises exclusively acrylonitrile and styrene as monomers.

24. The extruded foam according to claim 20, which uses, as blowing agent component (T), a mixture composed of carbon dioxide and ethanol.

25. The extruded foam according to claim 20, which uses, as blowing agent component (T), a mixture composed of carbon dioxide and acetone.

26. The extruded foam according to claim 20, which uses, as blowing agent component (T), a mixture composed of carbon dioxide and methyl formate.

27. The extruded foam according to claim 20, which uses, as blowing agent component (T), a mixture composed of carbon dioxide, acetone, and ethanol.

28. The extruded foam according to claim 24, wherein the total proportion of the blowing agent component (T) is at most 8% by weight (based on P) and is composed of carbon dioxide and ethanol, where the proportion of carbon dioxide is at most 6% by weight and the proportion of ethanol is at most 5% by weight.

29. The extruded foam according to claim 25, wherein the total proportion of the blowing agent component (T) is at most 8% by weight (based on P) and is composed of carbon dioxide and acetone, where the proportion of carbon dioxide is at most 6% by weight and the proportion of acetone is at most 5% by weight.

30. The extruded foam according to claim 27, wherein the total proportion of the blowing agent component (T) is at most 8% by weight (based on P) and is composed of carbon dioxide, acetone, and ethanol, where the proportion of carbon dioxide is at most 6% by weight and the proportion of the mixture composed of acetone and ethanol is at most 5% by weight.

31. The extruded foam according to claim 30, wherein the proportion of acetone is at least 50% by weight (based on the acetone/ethanol mixture).

32. A process for the production of an extruded foam with density in the range from 20 to 150 g/l, with a cell number in the range from 1 to 30 cells per mm, via
(a) heating of a polymer component (P), formed from
P1) from 80 to 100% by weight (based on P) of one or more styrene-acrylonitrile copolymers (SAN), comprising
a1) from 18 to 40% by weight (based on SAN) of copolymerized acrylonitrile,
a2) from 60 to 82% by weight (based on SAN) of copolymerized styrene, and
a3) from 0 to 22% by weight (based on SAN) of at least one copolymerized monomer from the group consisting of alkyl(meth)acrylates, (meth)acrylic acid, maleic anhydride and maleimides,
P2) from 0 to 20% by weight (based on P) of one or more thermoplastic polymers from the group consisting of styrene copolymers, polyolefins, polyacrylates, polycarbonates (PC), polyesters, polyamides, polyether sulfones (PES), polyether ketones (PEK), and polyether sulfides,
to form a polymer melt,
(b) introducing from 1 to 12% by weight (based on P) of a blowing agent component (T), which comprises less than 0.2% by weight of water (based on P), comprising
b1) from 15 to 95% by weight (based on T) of carbon dioxide and
b2) from 5 to 85% by weight (based on T) of one or more co-blowing agents selected from the group consisting of C₁-C₄ alcohols and C₁-C₄ carbonyl compounds,
into the polymer melt to form a foamable melt,
(c) extruding the foamable melt into a region of relatively low pressure, with foaming to give an extruded foam,
(d) optionally, adding additive materials to the polymer component (P) in at least one of the steps a), b) and/or c).

33. The process according to claim 32, wherein polymer component (P) is composed only of component (P1).

34. The process according to claim 32, wherein polymer component (P) comprises exclusively acrylonitrile and styrene as monomers.

35. The process according to claim 32, which uses, as blowing agent component (T), a mixture composed of carbon dioxide and ethanol.

36. The process according to claim 32, which uses, as blowing agent component (T), a mixture composed of carbon dioxide and acetone.

37. An insulation material comprising the extruded foam according to claim 20.

38. A structural foam comprising the extruded foam according to claim 20.
